(19) United States
(12) Patent Application Publication
(10) Pub. No.: US 2024/0256872 A1
(43) Pub. Date: Aug. 1, 2024

(54) BLOCKCHAIN-BASED AI MODEL TRAINING METHOD

(71) Applicant: TIANJIN UNIVERSITY OF SCIENCE & TECHNOLOGY, Tianjin (CN)

(72) Inventors: Yiying ZHANG, Tianjin (CN); Yingzhuo LI, Tianjin (CN); Ao ZHANG, Tianjin (CN); Cong WANG, Tianjin (CN); Kun LIANG, Tianjin (CN); Xiankun ZHANG, Tianjin (CN)

(21) Appl. No.: 18/687,673

(22) PCT Filed: Nov. 29, 2022
(86) PCT No.: PCT/CN2022/135194

§ 371 Date: Feb. 28, 2024

(30) Foreign Application Priority Data
Jul. 20, 2022 (CN) 202210859188.X

(51) Int. Cl. G06N 3/08; G06N 3/0464

(52) U.S. Cl. CPC G06N 3/08; G06N 3/0464

(57) ABSTRACT

A blockchain-based AI model training method is provided, comprising: building an original AI model according to features of data sets; randomly allocating participants in a training process proportionally into three categories: a model trainer, a model verifier and a model uploader, prior to start of each round of training of the original AI model; during each round of training, generating, by the model trainer and the model verifier, respective partial models of a current round; checking, by the model verifier, partial models generated by the model trainer through using partial models generated locally; aggregating, by the model uploader, all partial models passing the checking of the model verifier to obtain a global model of the current round, and packing the global model, checking results and all the partial models of the current round into a blockchain.

### CROSS-REFERENCE TO RELATED APPLICATION

This patent application is a national stage of International Application No. PCT/CN2022/135194, filed on Nov. 29, 2022, which claims the priority of Chinese Patent Application No. 202210859188.X filed with the China National Intellectual Property Administration on Jul. 20, 2022 and entitled as “BLOCKCHAIN-BASED AI MODEL TRAINING METHOD”, both of which are incorporated by reference herein in their entireties.

### TECHNICAL FIELD

The present disclosure relates to the technical field of artificial intelligence, in particular to a blockchain-based AI model training method.

### BACKGROUND

At present, there are two training methods of AI models, in which one method is a centralized learning training method, as shown in FIG. 1. The model training of machine learning algorithms in artificial intelligence is inseparable from the input of a large number of training data, and the quality and quantity of data samples directly determine the model effect. Theoretically, the more data, the higher the robustness of the trained model and the better the effect. However, with the strengthening of people's awareness of personal data protection, countries all over the world promulgate strict laws and regulations to restrict companies, organizations and individuals from collecting and disseminating the privacy information of users. The centralized learning method violates laws and regulations because the collected training data may involve the privacy of users, resulting in the inability to collect a large amount of training data and the inability to carry out subsequent model training.

The other method is a federated learning method, as shown in FIG. 2. Although this method solves the problem of privacy leakage, some other problems also arise, for example: i) the single-point failure problem of the central server that aggregates each round of partial model gradients appears, such as server downtime, or malicious attack which cause the model training unable to continue: ii) because the local data of users cannot be directly collected, there may be malicious nodes that use dirty data (i.e. untrue data or even contradictory data) to destroy the aggregation of models: iii) finally, there are differences in the data holding amount of each participant, and the nodes with a large number of samples may not be particularly interested in participating in federated learning.

Essentially, the blockchain is a shared database, and the data or information stored therein has features such as “decentralization”, “unforgeability”, “leaving trace in the whole process”, “traceability”, “openness and transparency”, “collective maintenance”.

Therefore, it is an urgent problem for those skilled in the art about how to provide a blockchain-based AI model training method, in which the blockchain is used to replace a central server of federated learning, so that the single-point failure problem of the central server of federated learning is solved, and meanwhile, it is convenient to trace accountability in the future, and the accuracy and robustness of the model are improved.

### SUMMARY

In view of this, the present disclosure provides a blockchain-based AI model training method, in which the blockchain is used to replace a central server of federated learning, so that the single-point failure problem of the central server of federated learning is solved, and meanwhile, it is convenient to trace accountability in the future, and the accuracy and robustness of the model are improved. Further, a model verification mechanism is proposed to prevent the poisoning attack of malicious nodes and ensure the convergence speed and accuracy of the model.

To achieve the above objective, the present disclosure uses the following technical solutions.

A blockchain-based AI model training method, including:
building an original AI model according to features of data sets;
randomly allocating participants in a training process proportionally into three categories: a model trainer, a model verifier and a model uploader, prior to start of each round of training of the original AI model;
during each round of training, obtaining, by the model trainer and the model verifier, global models of a last round from a blockchain, respectively, and training the global models through using local data sets to generate respective partial models of a current round;
checking, by the model verifier, partial models generated by the model trainer through using partial models generated locally;
aggregating, by the model uploader, all partial models passing the checking of the model verifier to obtain a global model of the current round, and packing the global model, checking results and all the partial models of the current round to the blockchain.

Further, the blockchain-based AI model training method described above further includes: striving, by the model uploader, for a right of uploading models to the blockchain through using a PoS consensus algorithm after packing data, where a model uploader who has acquired the right of uploading models to the blockchain packs data to the blockchain.

Further, in the blockchain-based AI model training method described above, if two or more model uploaders all acquire the right of uploading models to the blockchain at a same time, a bifurcation problem is solved according to a credit reward of each model uploader saved in the blockchain, and a block packed by a model uploader with a high credit reward is selected as a legal block.

Further, in the blockchain-based AI model training method described above, when the data sets are image data, the original AI model uses a convolutional neural network, and the convolutional neural network includes three convolution layers and two full connected layers.

Further, in the blockchain-based AI model training method described above, prior to the start of each round of training, the participants are allocated with a proportion relationship: T>V>M, where T is the model trainer, V is the model verifier, and M is the model uploader.

Further, in the blockchain-based AI model training method described above, during each round of training, an execution process of the model trainer includes:

downloading, by a model trainer tⁱ, a global model Gⱼ₋₁ of the last round from the blockchain, performing a training, with the global model Gⱼ₋₁ of the last round as a starting point of the training, through using local training sets, to obtain a local partial model L^{t}^{ⁱ}ⱼ, signing tx^{t}^{ⁱ}ⱼ by using its private key K^{t}^{ⁱ}ₚᵣᵢ and sending tx^{t}^{ⁱ}ⱼ to a model verifier, where the partial model L^{t}^{ⁱ}ⱼ and a credit reward of the model trainer tⁱ are encapsulated in L^{t}^{ⁱ}ⱼ.

Further, in the blockchain-based AI model training method described above, during each round of training, an execution process of the model verifier includes:
receiving, by the model verifier, tx^{t}^{ⁱ}ⱼ sent by the model trainer, verifying tx^{t}^{ⁱ}ⱼ through using a public key K^{t}^{ⁱ}_{pub} of the model trainer tⁱ, if the verifying fails, discarding tx^{t}^{ⁱ}ⱼ, and if the verifying passes, executing following steps:
downloading, by the model verifier v^{k}, the global model Gⱼ₋₁ of the last round from the blockchain, and performing a training, with the global model Gⱼ₋₁ of the last round as a starting point of the training, through using local training sets to obtain a local partial model L^{v}^{^{k}}ⱼ;
calculating, through using local testing sets, accuracies of the local partial model L^{t}^{ⁱ}ⱼ sent by the model trainer and the local partial model L^{v}^{^{k}}ⱼ trained by the model verifier, respectively, so as to obtain an accuracy

$${A ( {L}_{j}^{{t}^{i}} )}_{test {}_{{}_{v} k}}$$

of the partial model trained by the model trainer and an accuracy

$${A ( {L}_{j}^{{v}^{k}} )}_{test {}_{{}_{v} k}}$$

of the partial model trained by the model verifier:
checking the partial model trained by the model trainer by voting, according to the accuracies of two models;

encrypting, by the model verifier v^{k}, tx^{v}^{^{k}}ⱼ with its own private key K^{v}^{^{k}}ₚᵣᵢ after finishing checking, and then sending tx^{v}^{^{k}}ⱼ to the model uploader, where voting results, the partial model trained by the model trainer, a credit reward of the model verifier and the credit reward of the model trainer are encapsulated in tx^{v}^{^{k}}ⱼ.

Further, in the blockchain-based AI model training method described above, the checking the partial model of the model trainer by voting includes:
if the accuracy of the partial model trained by the model trainer is not lower than that of the partial model trained by the model verifier, that is,

$${A ( {L}_{j}^{{t}^{i}} )}_{test {}_{{}_{v} k}} \geq {A ( {L}_{j}^{{v}^{k}} )}_{test {}_{{}_{v} k}} ,$$

directly judging that the partial model L^{t}^{ⁱ}ⱼ trained by the model trainer is legal, and voting “Agree”:
otherwise, except for the legal partial model, denoting a remaining partial model L^{t}^{ⁱ}ⱼ trained by the model trainer as Tᵣₑₛₜ, and calculating a weighted accuracy difference according to following formula:

$$Av g = \frac{1}{\vert {T}_{r e s t} \vert} {\sum }_{k}^{{T}_{r e s t}} {A ( {L}_{j}^{{v}^{k}} )}_{test {}_{{}_{v} k}} - {A ( {L}_{j}^{{t}^{i}} )}_{t e s {t}_{{}_{v} k}}$$

judging a difference between an accuracy of all the remaining partial model t trained by the model trainer and the accuracy of the partial model trained by the model verifier and the weighted accuracy difference, where t∈Tᵣₑₛₜ, a judgment condition is as follows:

$${A ( {L}_{j}^{t} )}_{{test}_{{v}^{k}}} - {A ( {L}_{j}^{{v}^{k}} )}_{{test}_{{v}^{k}}} \geq Avg ?$$

if the above judgment condition is met, voting “Agree”: otherwise, judging that the partial model is illegal, and voting “Disagree”.

Further, in the blockchain-based AI model training method described above, an execution process of a model uploader includes:
receiving, by a model uploader m^{p}, tx^{v}^{^{k}}ⱼ sent by the model verifier, verifying tx^{v}^{^{k}}ⱼ with a public key K^{v}^{^{k}}_{pub} of the model verifier v^{k}, and discarding tx^{v}^{^{k}}ⱼ if the verifying fails;
counting, by each model uploader m^{p}, votes of all the model verifiers fora partial model L^{t}ⱼ trained by the model trainer, and calculating votes of each partial model L^{t}^{ⁱ}ⱼ;
if a number of legal partial models trained by the model trainer is greater than or equal to a number of illegal partial models, aggregating all the legal partial models, otherwise, doing nothing;
packing, by the model uploader m^{p}, the global model, voting results and all the partial models of the current round into a block block^{m}^{^{p}}ⱼ.

Further, in the blockchain-based AI model training method described above, a formula for aggregating all the legal partial models is as follows:

$${G}_{j} = {\sum }_{i ∈ legal} \frac{\vert {train}_{{t}^{i}} \vert}{\vert train\_total \vert} {L}_{j}^{{t}^{i}}$$

where Gⱼ is a global model generated in a j-th round of training: trainₜ_{ⁱ} is a number of training sets of the model trainer tⁱ; train_total is a total number of training sets of all legal model trainers; and L^{t}^{ⁱ}ⱼ is a partial model trained by tⁱ in the j-th round of training.

According to the above technical solutions, compared with the prior art, the present disclosure discloses a blockchain-based AI model training method, which has the following beneficial effects.

1. The present disclosure makes use of blockchain technology as an underlying architecture of federated learning, and randomly allocates participants to one of the above three identities prior to each algorithm iteration, which not only makes full use of the data of all parties for model training, but also prevents an attack of malicious nodes to some extent. Further, due to the introduction of blockchain technology, there is no single-point failure problem. Because each node in the blockchain is peer-to-peer, a node going offline will not affect the continuous operation of the system.

2. The present disclosure introduces a model verification algorithm based on a voting mechanism. The algorithm is aimed at model training verifiers and model trainers. In most instances, the model verifiers verify and vote on the models of the model trainers, which largely solves the poisoning attack problem existing in traditional federated learning.

3. The present disclosure introduces an incentive mechanism—a credit value, which is similar to the concept of Bitcoin in the Bitcoin system. The incentive mechanism rewards nodes that make contributions to the system. Further, the bifurcation problem in the blockchain can also be solved according to the level of the credit value. This improves the motivation of institutions to participate in federated learning, and encourages all parties to contribute local data to strengthen the effect of the model.

### BRIEF DESCRIPTION OF THE DRAWINGS

To describe the technical solutions in embodiments of the present disclosure or in the prior art more clearly, the accompanying drawings required in the description of the embodiments or the prior art will be briefly introduced hereinafter. Apparently, the accompanying drawings in the following description are only the embodiments of the present disclosure, and other drawings can be derived from these accompanying drawings by those of ordinary skill in the art without creative efforts.

FIG. 1 is a schematic diagram of a working mode of centralized learning in the prior art according to the present disclosure.

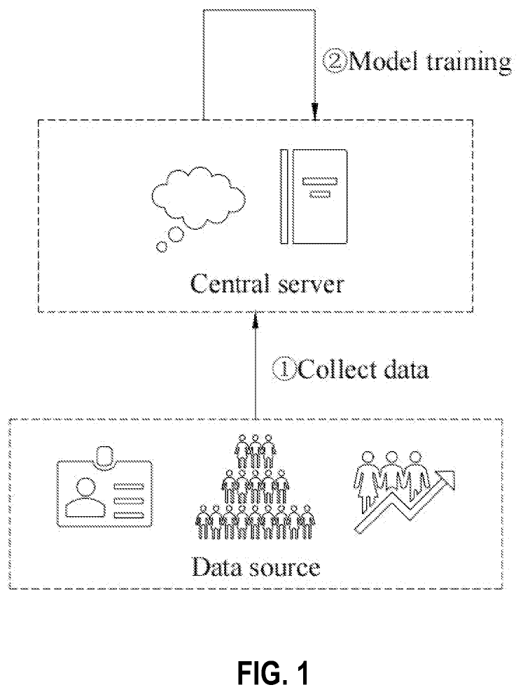

FIG. 2 is a schematic diagram of a working mode of federated learning in the prior art according to the present disclosure.

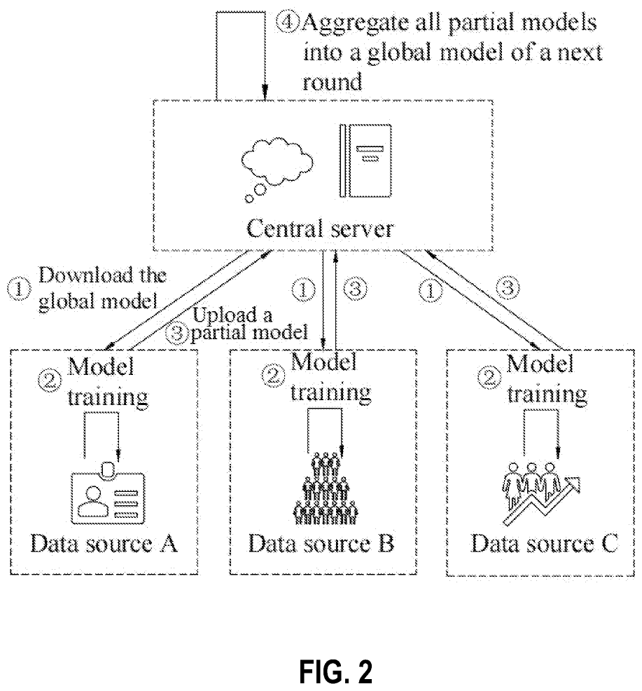

FIG. 3 is a comparison chart of accuracy results of simulation experiments of centralized learning, federated learning and poisoning attack according to the present disclosure.

FIG. 4 is a comparison chart of error results of simulation experiments of centralized learning, federated learning and poisoning attack according to the present disclosure.

FIG. 5 is a flowchart of a blockchain-based AI model training method according to the present disclosure.

FIG. 6 is a schematic structural diagram of a convolutional neural network according to the present disclosure.

FIG. 7 is a schematic diagram of a verification process of a model verifier according to the present disclosure.

### DETAILED DESCRIPTION OF THE EMBODIMENTS

The technical solutions in the embodiments of the present disclosure will be clearly and completely described hereinafter with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the protection scope of the present disclosure.

Prior to the start of the training, the present disclosure conducts the following experiment to verify an influence of poisoning on the accuracy of model training, which is specifically described as follows.

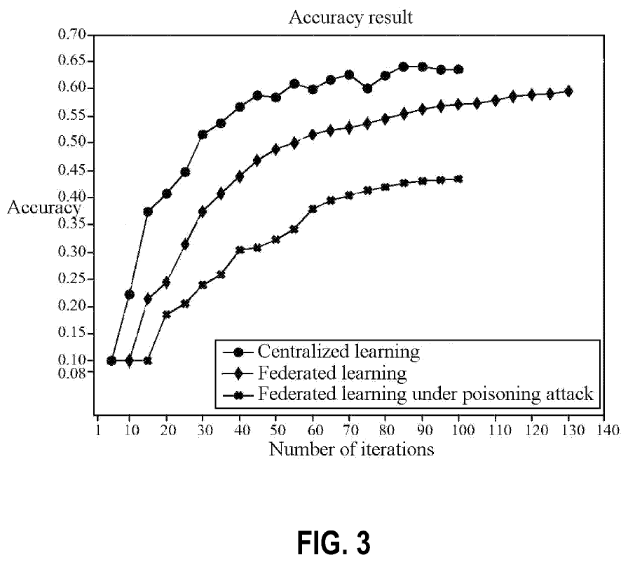

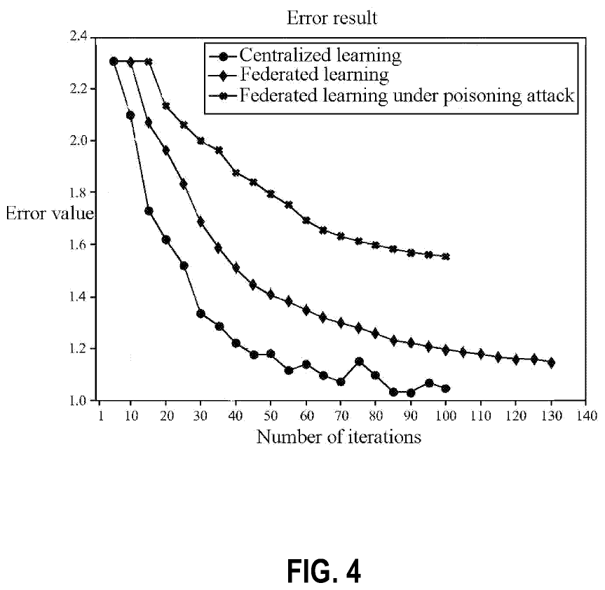

In the experiment, 50,000 training sets are evenly divided into 10 parts, in which each part contains 5,000 data to simulate 10 participants. Centralized learning is to collect the 50,000 data to a central server for training. Federal learning is a joint training model of 10 participants. On the basis of federated learning, the poisoning attack simulates the existence of two malicious nodes, which move labels of 10% of data (500 samples) backward by one label, namely (y+1)%10, so as to simulate the poisoning attack of malicious participants, thus destroying the aggregation of the global model and the model effect. As shown in FIG. 3 and FIG. 4, it can be concluded that the accuracy of federated learning is not much different from that of centralized learning, which is within an acceptable range. However, the convergence speed of the federated learning model is slightly slower than that of centralized learning. Further, only the data accounting for 1000:50000 (=0.02) of the whole data suffer from poisoning, which reduces the accuracy of the model to 44%. It can be seen that it is necessary to guard against poisoning attacks.

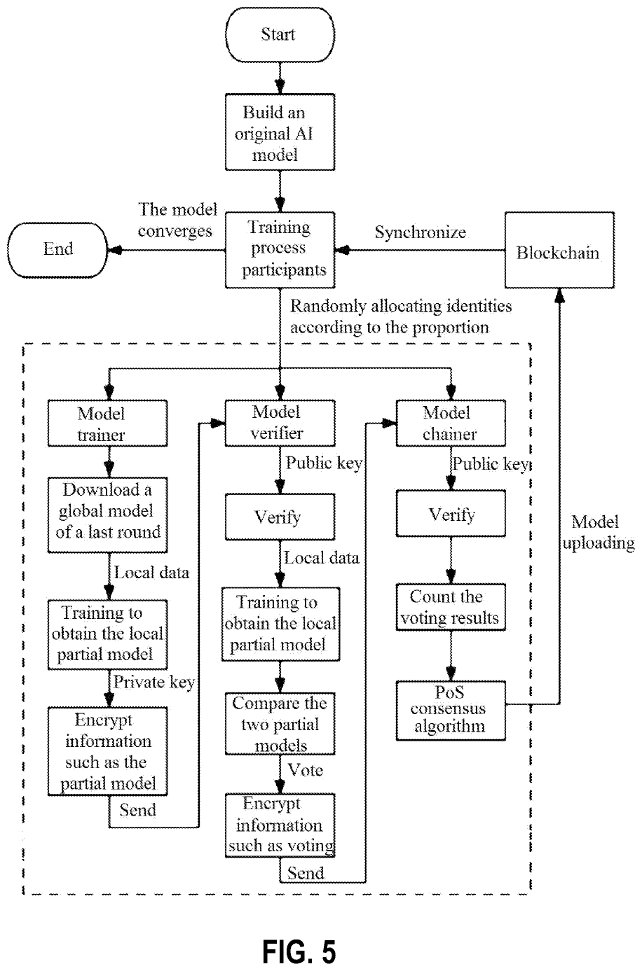

In view of this, as shown in FIG. 5, an embodiment of the present disclosure discloses a blockchain-based AI model training method, which includes the following steps S1-S3.

In S1, an original AI model is built according to features of a data set.

In S2, prior to start of each round of training of the original AI model, participants in a training process are randomly allocated into three categories proportionally: model trainers, model verifiers and model uploaders.

In S3, during each round of training, the model trainers and the model verifiers obtain a global model of a last round from a blockchain, respectively, and local data sets are used for training to generate respective partial models of a current round.

The model verifiers use partial models generated locally to check partial models generated by the model trainers.

The model uploaders aggregate all partial models passing the check of the model verifiers to obtain a global model of the current round, and pack the global model, checking result and all the partial models of the current round into the blockchain.

The above steps will be further described hereinafter.

Specifically, in S1, an appropriate AI algorithm model is selected according to the features of the data sets.

First, for a specific data set, it is necessary to choose a model algorithm that can get better results in the case of centralized learning (for traditional model training, data is collected in the central server for model training). If the data features are nonlinear, a linear algorithm cannot be selected for model training, so that the effect of the models trained by centralized learning is not ideal, and the effect of distributed model training is even less likely to be good.

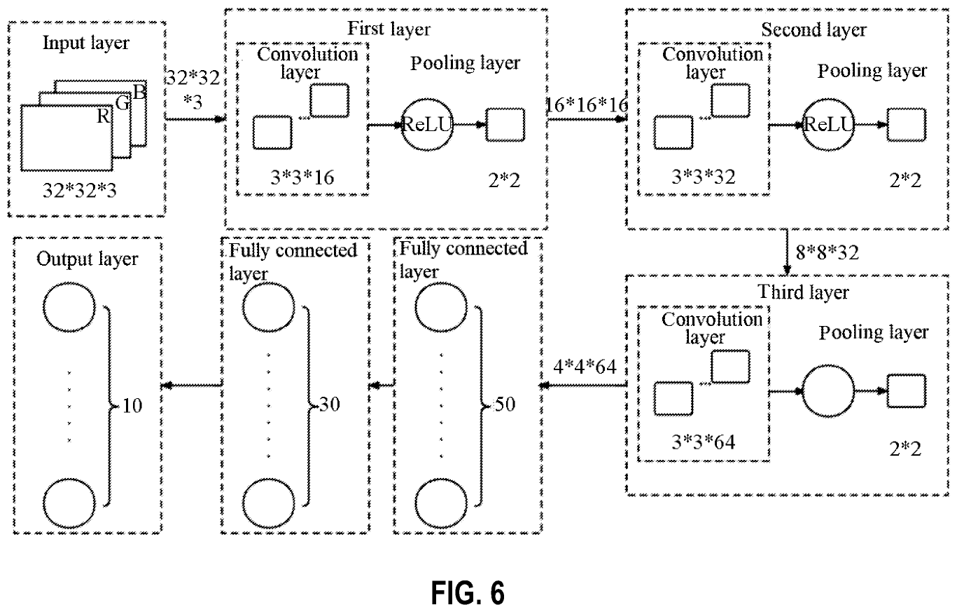

A suitable algorithm is selected for image data, that is, a convolution neural network. For a Cifar-10) data set, Cifar-10) is a 3-channel color 3*32*32RGB image. The data set includes 50,000 training pictures and 10,000 test pictures. Each picture contains 32*32*3 RGB images. The labels are divided into 10 categories including animals and vehicles, namely airplanes, automobiles, birds, cats, deer, dogs, frogs, horses, ships and trucks. The embodiment of the present disclosure builds a simple convolutional neural network for training. The specific schematic diagram of the built convolutional neural network is shown in FIG. 6 (other parameters stride=1, padding=1). The image data of 32*32*3 is transformed into 16*16*16 after passing through a first convolution layer, transformed into 8*8*32 after passing through a second convolution layer, and transformed into 4*4*64 after passing through a third convolution layer. Before entering a full connected layer, a three-dimensional matrix is flattened into one-dimensional data. After passing through two full connected layers, a one-dimensional vector with the size of 10 is finally output, and the probability of classification at the corresponding position is obtained through the softmax activation function.

In a specific embodiment, in S2, prior to the start of the current round of training, the present disclosure randomly allocates identities of participants proportionally. A allocation proportion relationship is: T>V>M, where T is the model trainers. V is the model verifiers, and M is the model uploaders, so that most nodes are model trainers, the second most nodes are model verifiers, and the least modes are model uploaders. The purpose is to allow more data to participate in real training, so that the model can converge faster with fewer iterations. Of course, it is also possible to appropriately increase the proportion of model verifiers, which has the advantage of improving the overall effect of preventing malicious node attacks.

Prior to each round of training, the identities of the participants are classified, which has the advantage of refusing a malicious node to “do evil” in a certain “post” for a long time. At the same time, the data of all legal nodes can be made full use of for model training.

In a specific embodiment, in S3, each participant completes his own task according to his own identity, which specifically includes the following steps S31-S33.

In S31, during each round of training, an execution process of the model trainer includes the following steps.

For all model trainers, tⁱ∈T, a model trainer tⁱ downloads a global model Gⱼ₋₁ of the last round from the blockchain, uses the local training set for training based on the global model Gⱼ₋₁ of the last round as the training starting point, to obtain a local partial model L^{t}^{ⁱ}ⱼ, signs tx^{t}^{ⁱ}ⱼ by using his private key K^{t}^{ⁱ}ₚᵣᵢ and sends it to a model verifier, where the partial model L^{t}^{ⁱ}ⱼ and a credit reward of the model trainer tⁱ are encapsulated in tx^{t}^{ⁱ}ⱼ. At this point, the training task of the model trainer in the current round ends.

In S32, during each round of training, an execution process of the model verifier includes the following steps.

1) For all model verifiers, v^{k}∈V, a model verifier v^{k} receives tx^{t}^{ⁱ}ⱼ sent by all the model trainers, verify tx^{t}^{ⁱ}ⱼ through using a public key K^{t}^{ⁱ}_{pub} of the model trainer tⁱ to ensure that the content has not been tampered with and it is sent by tⁱ, if the verification fails, discards it, and if the verification passes, executes the following steps.

2) The model verifier v^{k} downloads the global model Gⱼ₋₁ of the last round from the blockchain, uses the local training set for training based on the global model Gⱼ₋₁ of the last round as the training starting point, to obtain a local partial model L^{v}^{^{k}}ⱼ.

3) Local test sets are used to calculate accuracies of the local partial model L^{t}^{ⁱ}ⱼ sent by the model trainer and the local partial model L^{v}^{^{k}}ⱼ trained by the model trainer, respectively, so as to obtain an accuracy

$${A ( {L}_{j}^{{t}^{i}} )}_{{test}_{{v}^{k}}}$$

of the partial model trained by the model trainer and the accuracy

$${A ( {L}_{j}^{{v}^{k}} )}_{{test}_{{v}^{k}}}$$

of the partial model trained by the model verifier.

4) According to the accuracies of the two models, the partial model trained by the model trainer is checked by voting. Because they are the same kind of data sets, the training set trainᵥ_{ₖ} of the model verifier and the training set trainₜ_{ⁱ} of the model trainer obey the same probability distribution. This verification method uses this principle to check the local partial model of the model trainer.

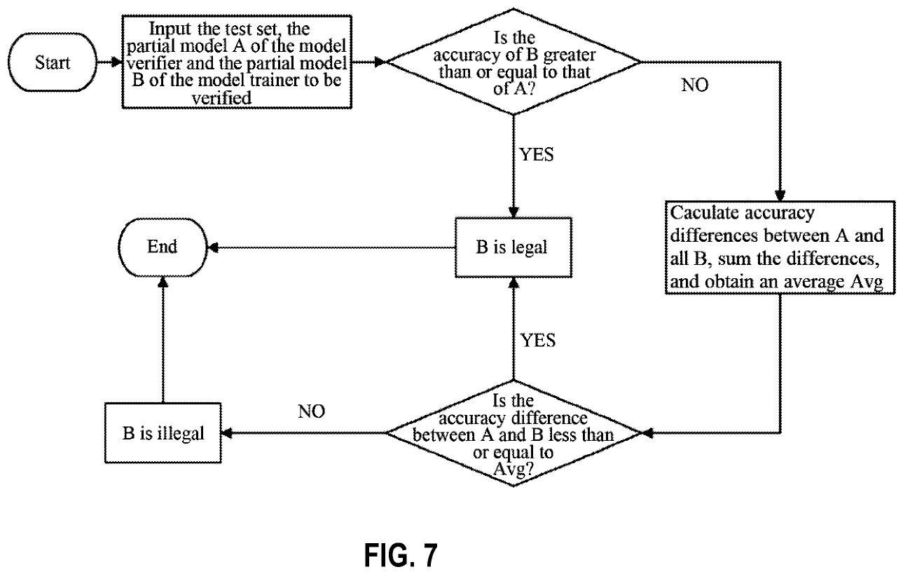

As shown in FIG. 7, the checking the partial model of the model trainer by voting is as follows.

If the accuracy of the partial model trained by the model trainer is not lower than that of the partial model trained by the model verifier, that is,

$${A ( {L}_{j}^{{t}^{i}} )}_{{test}_{{v}^{k}}} \geq {A ( {L}_{j}^{{v}^{k}} )}_{{test}_{{v}^{k}}} ,$$

it is directly judged that the partial model L^{t}^{ⁱ}ⱼ trained by the model trainer is legal, and “Agree” is voted.

Otherwise, except for the legal partial model, the remaining partial models L^{t}^{ⁱ}ⱼ trained by the model trainer are denoted as Tᵣₑₛₜ, and a weighted accuracy difference is calculated according to the following formula:

$$Avg = \frac{1}{\vert {T}_{rest} \vert} {{\sum }^{{T}_{rest}}}_{k} {A ( {L}_{j}^{{v}^{k}} )}_{{test}_{{v}^{k}}} - {A ( {L}_{j}^{{t}^{i}} )}_{{test}_{{v}^{k}}} .$$

A difference between an accuracy of all the remaining partial model t trained by the model trainer and the accuracy of the partial model trained by the model verifier and the weighted accuracy difference are judged, where t∈Tᵣₑₛₜ, a judgment condition is as follows:

$${A ( {L}_{j}^{t} )}_{{test}_{{v}^{k}}} - {A ( {L}_{j}^{{v}^{k}} )}_{{test}_{{v}^{k}}} \geq Avg ?$$

If the above judgment condition is met, “Agree” is voted: otherwise, it is judged that the partial model is illegal, and “Disagree” is voted.

4) After finishing checking, the model verifier v^{k} encrypts tx^{v}^{^{k}}ⱼ with his own private key K^{v}^{^{k}}ₚᵣᵢ, and then sends it to the model uploader to ensure that the content has not been tampered with and it is sent by tⁱ. If the verification fails, it is discarded. Voting results, the partial model trained by the model trainer, the credit reward of the model verifier and the credit reward of the model trainer are encapsulated in tx^{v}^{^{k}}ⱼ.

At this point, the training task of the model verifier in the current round ends.

In S33, an execution process of the model uploader includes the following steps.

For all model uploaders, m^{p}∈M, a model uploader m^{p} receives tx^{v}^{^{k}}ⱼ sent by all the model verifiers, and verifies tx^{v}^{^{k}}ⱼ with the public key K^{t}^{ⁱ}_{pub} of the model verifier v^{k} to ensure that the content has not been tampered with and it is sent by the model verifier v^{k}. If the verification fails, it is discarded.

Each model uploader m^{p} counts votes of all the model verifiers fora partial model L^{t}ⱼ trained by the model trainer from, and calculates votes of each partial model L^{t}^{ⁱ}ⱼ.

If a number of legal partial models trained by the model trainer is greater than or equal to a number of illegal partial models, all the legal partial models are aggregated, otherwise, nothing is done. A comparison formula is:

$$count ( legal ) ⩾ count ( illegal ) ?$$

If the above formula is correct, it is used as the input for calculating Gⱼ, otherwise, nothing is done.

That is, the partial models with more than half of the votes “Agree” are aggregated to form the global model of the current round. The method can be summarized as: a federated average (FedAvg) algorithm, the core idea of which is to allocate weights to L^{t}^{ⁱ}ⱼ according to the ratio of the number of training sets of the model trainers tⁱ to the total number of training sets of all the legal model trainers. The specific aggregation formula is as follows:

$${G}_{j} = {\sum }_{i ∈ legal} \frac{\vert {train}_{{t}^{i}} \vert}{\vert train\_total \vert} {L}_{j}^{{t}^{i}}$$

where Gⱼ is the global model generated in the j-th round of training: trainₜ_{ⁱ} is the train number of training sets of the model trainer tⁱ: train_total is the total number of training sets of all the legal model trainers; and L^{t}^{ⁱ}ⱼ is the partial model trained by tⁱ in the j-th round of training.

The model uploader m^{p} packs the global model, voting results and all the partial models of the current round into a block block^{m}^{^{P}}ⱼ.

In a more advantageous embodiment, S3 further includes the following steps.

After the model uploader packs data, a PoS consensus algorithm is also used to gain a right of uploading models to the blockchain, where a model uploader who has acquired the right of uploading models to the blockchain packs data on the blockchain.

If two or more model uploaders all acquire the right of uploading models to the blockchain at the same time, a bifurcation problem is solved according to the credit reward of each model uploader saved in the blockchain, and a block packed by the model uploader with a high credit reward is selected as a legal block.

All key information has been uploaded to the blockchain, and the content cannot be changed, so that it can be traced, verified and held accountable in the future. Moreover, the credit value can be linked to the financial system and be in line with the commodities in the real world. In this way, the credit value is enhanced, thus encouraging more people to participate in the system and making the AI model have a better effect.

At this point, the training task of the model uploader in the current round ends.

S2-S3 are repeated until the AI model converges (the model effect cannot be improved by iteration), and the task ends.

A constant number of iterations may be defined or a condition that the difference between the parameters of the global models for two adjacent rounds of training is less than a very small positive number may be defined as the task end condition.

Definitions of related parameters involved in the embodiments of the present disclosure are uniformly explained below, as shown in Table 1:

TABLE 1
Description of parameter definition

| Symbol | Description |
|---|---|
| Algrithm | A machine learning algorithm used for a target training set |
| pⁱ ϵ P | The i-th participant participating in distributed training |
| tⁱ ϵ T | The i-th trainer in the model trainers |
| vⁱ ϵ V | The i-th verifier in the model verifiers |
| mⁱ ϵ M | The i-th miner in the model uploaders |
| Kₚᵣᵢ^{p}^{ⁱ}, K_{pub}^{p}^{ⁱ} | A public key and a private key of a participant pⁱ |
| Lⱼ^{t}^{ⁱ} | A partial model trained by tⁱ in the j-th round of training |
| testᵢ, trianᵢ | A test set and a training set of the i-th participant |
| A(Lⱼ^{t})ₜₑₛₜ_{ᵢ} | An accuracy of a partial model trained by t for a test set |
| | i in the j-th round of training |
| Gⱼ | A global model of the j-th round of training |
| vrⱼⁱ (Lⱼ^{t}^{ⁱ}) | An verification result of Lⱼ^{t}^{ⁱ} by vⁱ in the j-th round of |
| | training |
| rⱼ^{t}^{ⁱ}, rⱼ^{v}^{ⁱ}, rⱼ^{m}^{ⁱ} | Credit rewards obtained by tⁱ, vⁱ and mⁱ in the j-th round |
| | of training |
| txⱼ^{t}^{ⁱ} | {Lⱼ^{t}^{ⁱ}, rⱼ^{t}^{ⱼ}} encapsulated by tⁱ in the j-th round of training |
| txⱼ^{v}^{ⁱ} | {txⱼ^{t}^{ⁱ}, vⱼⁱ (Lⱼ^{t}^{ⁱ}), rⱼ^{t}^{ⁱ}} encapsulated by vⁱ in the j-th round |
| | of training |
| resultⱼ | A verification result of V in the j-th round of training |
| blockkⱼ^{m}^{ⁱ} | A block {resultⱼ, Gⱼ, txⱼ^{V}, rⱼ^{m}^{ⁱ}} dug out by mⁱ in the j-th |
| | round of training |

Embodiments of the present specification are described in a progressive manner, each embodiment focuses on the difference from other embodiments, and the same and similar parts between the embodiments may refer to each other. Since the apparatus disclosed in an embodiment corresponds to the method disclosed in another embodiment, the description is relatively simple, and reference can be made to the method description.

The above description of the disclosed embodiments enables those skilled in the art to make or use the present disclosure. Many modifications to these embodiments will be apparent to those skilled in the art, and the general principles defined herein can be implemented in other embodiments without departing from the spirit or scope of the present disclosure. Therefore, the present disclosure should not be limited to the embodiments shown herein, but should conform to the widest scope consistent with the principles and novel features disclosed herein.

What is claimed is:

1. A blockchain-based AI model training method, comprising:
building an original AI model according to features of data sets;
randomly allocating participants in a training process proportionally into three categories: a model trainer, a model verifier and a model uploader, prior to start of each round of training of the original AI model;
during each round of training, obtaining, by the model trainer and the model verifier, global models of a last round from a blockchain, respectively, and training the global models through using local data sets to generate respective partial models of a current round;
checking, by the model verifier, partial models generated by the model trainer through using partial models generated locally;
aggregating, by the model uploader, all partial models passing the checking of the model verifier to obtain a global model of the current round, and packing the global model, checking results and all the partial models of the current round to the blockchain.

2. The blockchain-based AI model training method according to claim 1, further comprising: striving, by the model uploader, for a right of uploading models to the blockchain through using a PoS consensus algorithm after packing data, wherein a model uploader who has acquired the right of uploading models to the blockchain packs data to the blockchain.

3. The blockchain-based AI model training method according to claim 2, wherein if two or more model uploaders all acquire the right of uploading models to the blockchain at a same time, a bifurcation problem is solved according to a credit reward of each model uploader saved in the blockchain, and a block packed by a model uploader with a high credit reward is selected as a legal block.

4. The blockchain-based AI model training method according to claim 1, wherein when the data sets are image data, the original AI model uses a convolutional neural network, and the convolutional neural network comprises three convolution layers and two full connected layers.

5. The blockchain-based AI model training method according to claim 1, wherein, prior to the start of each round of training, the participants are allocated with a proportion relationship: T>V>M, wherein T is the model trainer, V is the model verifier, and M is the model uploader.

6. The blockchain-based AI model training method according to claim 1, wherein during each round of training, an execution process of the model trainer comprises:
downloading, by a model trainer tⁱ, a global model Gⱼ₋₁ of the last round from the blockchain, performing a training, with the global model Gⱼ₋₁ of the last round as a starting point of the training, through using local training sets, to obtain a local partial model L^{t}^{ⁱ}ⱼ, signing tx^{t}^{ⁱ}ⱼ by using its private key K^{t}^{ⁱ}ₚᵣᵢ and sending tx^{t}^{ⁱ}ⱼ to a model verifier, wherein the partial model L^{t}^{ⁱ}ⱼ and a credit reward of the model trainer tⁱ are encapsulated in L^{t}^{ⁱ}ⱼ.

7. The blockchain-based AI model training method according to claim 6, wherein during each round of training, an execution process of the model verifier comprises:
receiving, by the model verifier, tx^{t}^{ⁱ}ⱼ sent by the model trainer, verifying tx^{t}^{ⁱ}ⱼ through using a public key K^{t}^{ⁱ}_{pub} of the model trainer tⁱ, if the verifying fails, discarding tx^{t}^{ⁱ}ⱼ, and if the verifying passes, executing following steps:
downloading, by the model verifier v^{k}, the global model Gⱼ₋₁ of the last round from the blockchain, and performing a training, with the global model Gⱼ₋₁ of the last round as a starting point of the training, through using local training sets to obtain a local partial model L^{v}^{^{k}}ⱼ;
calculating, through using local testing sets, accuracies of the local partial model L^{t}^{ⁱ}ⱼ sent by the model trainer and the local partial model L^{v}^{^{k}}ⱼ trained by the model verifier, respectively, so as to obtain an accuracy
$${A ( {L}_{j}^{{t}^{i}} )}_{{test}_{{v}^{k}}}$$
of the partial model trained by the model trainer and an accuracy
$${A ( {L}_{j}^{{v}^{k}} )}_{{test}_{{v}^{k}}}$$
of the partial model trained by the model verifier;
checking the partial model trained by the model trainer by voting, according to the accuracies of two models;
encrypting, by the model verifier v^{k}, tx^{v}^{^{k}}ⱼ with its own private key K^{v}^{^{k}}ₚᵣᵢ after finishing checking, and then sending tx^{v}^{^{k}}ⱼ to the model uploader, wherein voting results, the partial model trained by the model trainer, a credit reward of the model verifier and the credit reward of the model trainer are encapsulated in tx^{v}^{^{k}}ⱼ.

8. The blockchain-based AI model training method according to claim 7, wherein the checking the partial model of the model trainer by voting comprises:
if the accuracy of the partial model trained by the model trainer is not lower than that of the partial model trained by the model verifier, that is,
$${A ( {L}_{j}^{{t}^{i}} )}_{{test}_{{v}^{k}}} \geq {A ( {L}_{j}^{{v}^{k}} )}_{{test}_{{v}^{k}}} ,$$
directly judging that the partial model L^{t}^{ⁱ}ⱼ trained by the model trainer is legal, and voting “Agree”:
otherwise, except for the legal partial model, denoting a remaining partial model L^{t}^{ⁱ}ⱼ trained by the model trainer as Tᵣₑₛₜ, and calculating a weighted accuracy difference according to following formula:
$$Avg = \frac{1}{\vert {T}_{rest} \vert} {{\sum }^{{T}_{rest}}}_{k} {A ( {L}_{j}^{{v}^{k}} )}_{{test}_{{v}^{k}}} - {A ( {L}_{j}^{{t}^{i}} )}_{{test}_{{v}^{k}}}$$
judging a difference between an accuracy of all the remaining partial model t trained by the model trainer and the accuracy of the partial model trained by the model verifier and the weighted accuracy difference, wherein t∈Tᵣₑₛₜ, a judgment condition is as follows:
$${A ( {L}_{j}^{t} )}_{{test}_{{v}^{k}}} - {A ( {L}_{j}^{{v}^{k}} )}_{{test}_{{v}^{k}}} \geq Avg ?$$
if the above judgment condition is met, voting “Agree”: otherwise, judging that the partial model is illegal, and voting “Disagree”.

9. The blockchain-based AI model training method according to claim 7, wherein an execution process of a model uploader comprises:
receiving, by a model uploader m^{p}, tx^{v}^{^{k}}ⱼ sent by the model verifier, verifying with a public key K^{v}^{^{k}}_{pub} of the model verifier v^{k}, and discarding tx^{v}^{^{k}}ⱼ if the verifying fails;
counting, by each model uploader m^{p}, votes of all the model verifiers fora partial model L^{t}ⱼ trained by the model trainer, and calculating votes of each partial model L^{t}^{ⁱ}ⱼ;
if a number of legal partial models trained by the model trainer is greater than or equal to a number of illegal partial models, aggregating all the legal partial models, otherwise, doing nothing;
packing, by the model uploader m^{p}, the global model, voting results and all the partial models of the current round into a block block^{m}^{^{p}}ⱼ.

10. The blockchain-based AI model training method according to claim 9, wherein a formula for aggregating all the legal partial models is as follows:
$${G}_{j} = {\sum }_{i ∈ legal} \frac{\vert {train}_{{t}^{i}} \vert}{\vert train\_total \vert} {L}_{j}^{{t}^{i}}$$
wherein Gⱼ is a global model generated in a j-th round of training; trainₜ_{ⁱ} is a number of training sets of the model trainer tⁱ; train_total is a total number of training sets of all legal model trainers; and L^{t}^{ⁱ}ⱼ is a partial model trained by tⁱ in the j-th round of training.
